(19) United States
(12) Patent Application Publication
(10) Pub. No.: US 2006/0067540 A1
(43) Pub. Date: Mar. 30, 2006

(54) Method for signal nonlinear distortion detection and adaptive gain control

(76) Inventors: Xiao M. Gao, Sacramento, CA (US); Qing-lun Chen, El Dorado Hills, CA (US)

Correspondence Address: Buckley, Maschoff & Talwalkar LLC, Five Elm Street, New Canaan, CT, 06840, US

(21) Appl. No.: 10/952,068

(22) Filed: Sep. 28, 2004

(51) Int. Cl. H04R 3/00

(52) U.S. Cl. 381/92; 381/113; 381/122

(57) ABSTRACT

An apparatus includes a microphone to generate a voice signal. The apparatus further includes an adjustable gain circuit coupled to the microphone to selectively apply a gain to the voice signal. In addition the apparatus includes an analog front end circuit coupled to the adjustable gain circuit to transmit the voice signal via a telephone line. Also, the apparatus includes a control circuit coupled to the adjustable gain circuit. The control circuit is operative to detect an average level of energy of the voice signal outside of a voice frequency band. The control circuit is further operative to control, based at least in part on the detected average level of energy, an amount of gain applied to the voice signal by the adjustable gain circuit.

### BACKGROUND

It has been proposed to interface a speakerphone arrangement to a personal computer so that hands-free telephone conversation can be transmitted via a modem that is part of the computer. The analog audio signal which corresponds to the audible voice captured by the microphone portion of the speakerphone is digitized by an analog-to-digital converter (ADC) before being fed to the modem. If the volume of the audible voice is great and/or if the amount of gain applied to the audio signal is rather high, there may be signal distortion along the signal path, which may lead to poor sound quality at the receiving end. The distortion may arise due to clipping at the ADC, because the ADC has a limited dynamic range. The clipping may also cause nonlinearity in the signal path, possibly leading to interference with an automatic echo cancellation (AEC) function in the modem. This too may compromise sound quality at the receiving end.

### BRIEF DESCRIPTION OF THE DRAWINGS

FIG. 1 is a simplified block diagram of a host-based speakerphone system provided according to some embodiments.

FIG. 2 is a block diagram that shows some details of a host personal computer that is part of the system of FIG. 1.

FIG. 3 is a block diagram that shows some details of a speakerphone audio signal path and related control functions in the system of FIG. 1.

FIG. 4 is a flow chart that illustrates a process performed in accordance with some embodiments by the control functions of FIG. 3.

FIG. 5 is a simulated plot of a test voice signal that may be applied to the system of FIG. 1.

FIG. 6 is a simulated plot of the test signal of FIG. 5, when oversampled with microphone boost disabled and microphone volume control set at midrange.

FIG. 7 is a simulated 2D spectrogram of the test signal under the conditions of FIG. 6.

FIG. 8 is a simulated 3D spectrogram of the test signal under the conditions of FIG. 6.

FIG. 9 is a simulated plot of the test signal of FIG. 5, when oversampled and with microphone boost applied and the microphone volume control set at a high level.

FIG. 10 is a simulated 2D spectrogram of the test signal under the conditions of FIG. 9.

FIG. 11 is a simulated 3D spectrogram of the test signal under the conditions of FIG. 10.

FIG. 12 is a simulated plot of the test signal showing effects of a gain adjustment process provided in accordance with some embodiments.

FIG. 13 is a simulated 2D spectrogram of the test signal showing effects of the gain adjustment process provided in accordance with some embodiments.

FIG. 14 is a simulated 3D spectrogram of the test signal showing effects of the gain adjustment process provided in accordance with some embodiments.

FIG. 15 is a block diagram illustration of a driver software architecture in which some embodiments may be implemented.

### DETAILED DESCRIPTION

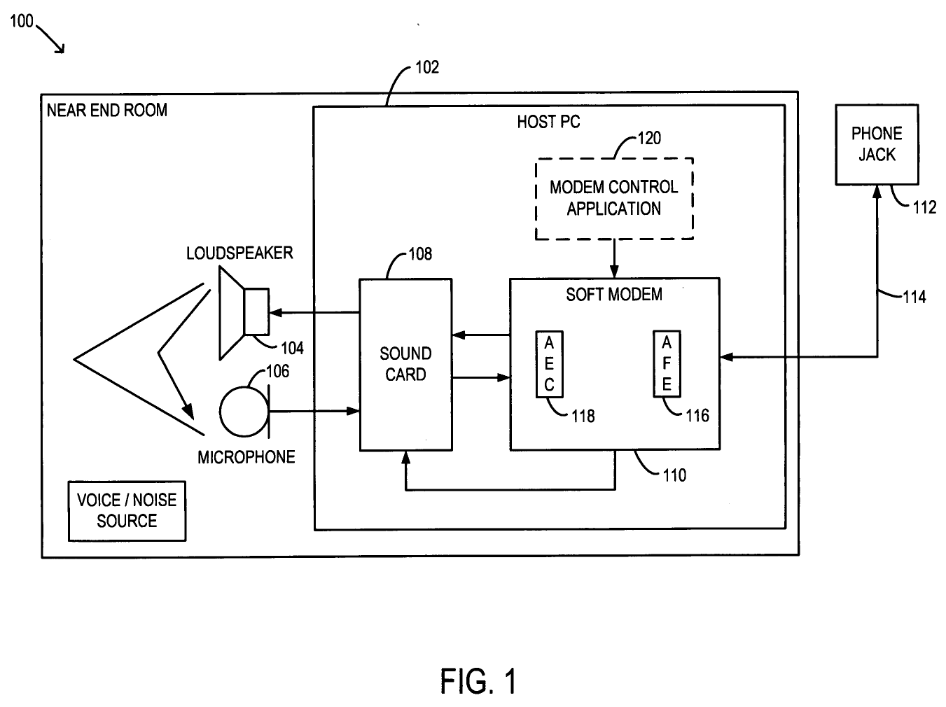

FIG. 1 is a simplified block diagram of a host-based speakerphone system 100 provided according to some embodiments.

The system 100 includes a host computer 102 (e.g., a personal computer). The system 100 also includes a loudspeaker 104 and a microphone 106. The loudspeaker 104 and the microphone 106 are coupled to the host computer 102 via a sound card 108 that is part of the host computer 102. The microphone 106 is operative in a conventional fashion to generate an analog electrical voice signal that represents an audible voice captured by the microphone 106. The host computer 102 also includes a modem 110, by which the host computer 102 is coupled to telephone jack 112. A telephone line, which is not separately shown, terminates at the telephone jack. A cable, indicated at 114, couples the modem 110 to the telephone jack 112.

The modem 110 may be of the type commonly referred to as a “soft modem”. As is familiar to those who are skilled in the art, a soft modem is one in which at least some functions (e.g., DSP and control functions) performed by hardware in a traditional modem are instead handled by the CPU (not separately shown in FIG. 1) of the host computer. The modem 110 is coupled between the sound card 108 and the cable 114 and includes an analog front end circuit 116 which provides an interface to the telephone line. In addition, the modem 110 may include an automatic echo cancellation circuit 118 which is coupled to the microphone 106, via the sound card 108. The automatic echo cancellation circuit 118 is operative to automatically cancel a signal picked up by the microphone from the speaker during operation of the system 100.

It will be appreciated that the microphone 106 operates to generate a voice signal that is processed by the sound card 108 and the modem 110 to be transmitted via the telephone line. Similarly the speaker 104 is coupled to the analog front end circuit 116 via the sound card 108 and is operative to audibly reproduce a signal received by the system 100 via the telephone line.

Also indicated in FIG. 1 is modem control application software 120 which runs in the host computer 102. The modem control application software may perform some control functions relative to the modem 110 including functions provided in accordance with embodiments which are described below.

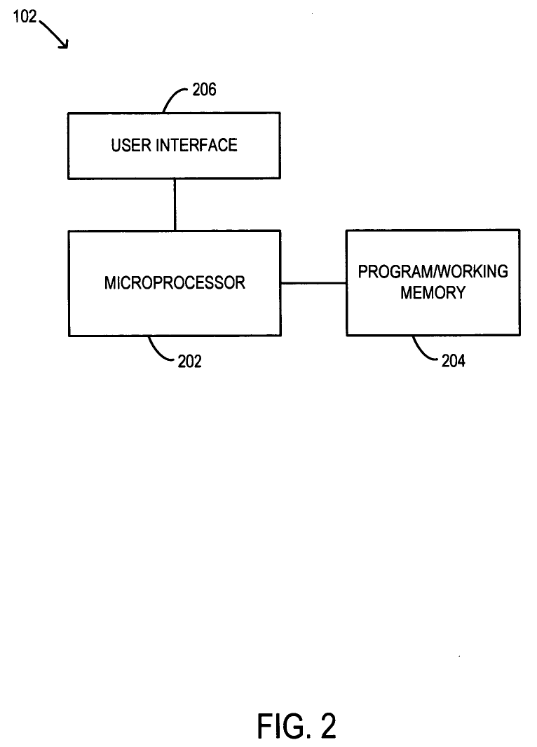

FIG. 2 is a block diagram that shows some details of the host computer 102, as provided according to some embodiments. In addition to other components which are either not shown or are indicated in FIG. 1, the host computer 102 may include a conventional microprocessor 202, such as, for example, a Pentium® microprocessor manufactured by Intel Corporation, which is the assignee hereof. In addition, the host computer 102 may include various memory devices (generally represented by block 204 in FIG. 2) which are coupled to the microprocessor 202. The memory devices 204 may perform various functions, such as working memory and temporary or permanent storage of software program instructions that control operation of the microprocessor 202. The host computer may further include user interface devices 206 coupled to the microprocessor 202. The user interface devices 206 may include such conventional items as a keyboard, mouse, display monitor, etc., which are not separately shown. Although not shown in the drawings, the host computer 102 may also include mass storage such as a hard drive, as well as other conventional components.

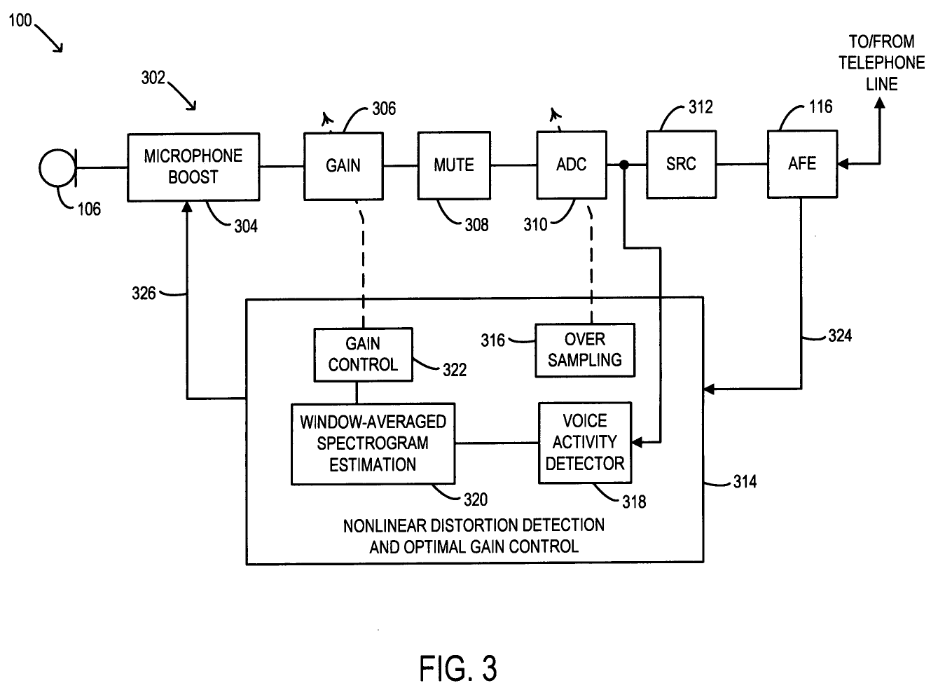

FIG. 3 illustrates in functional block form certain aspects of the speakerphone system 100, as provided in accordance with some embodiments. In particular FIG. 3 illustrates details of the outbound audio signal path 302 and related control functions. The audio signal path processes an electrical voice signal generated by the microphone 106 so that the voice signal is transmitted via the telephone line (not shown). In general the audio path for the received signal is omitted to simplify the drawing.

The audio signal path 302 may include a microphone boost circuit 304 that is coupled to the microphone 106. The microphone boost circuit, when enabled, may provide a fixed gain (e.g. 20 dB) to the voice signal generated by the microphone 106.

Further, in accordance with some embodiments, the audio signal path 302 may include an adjustable gain circuit 306 that is coupled to the microphone 106 via the microphone boost circuit 304. (Thus the microphone boost circuit may be coupled between the microphone 106 and the adjustable gain circuit 306.) The adjustable gain circuit 306 may selectively apply a gain to the voice signal generated by the microphone 106 in accordance with a control process which is described below.

Coupled to the adjustable gain circuit 306, downstream therefrom, there may be a mute circuit 308. The mute circuit may selectively be operated to mute the voice signal generated by the microphone 106. A control connection to the mute circuit 308 may be present but is not shown.

There may also be coupled to the adjustable gain circuit 306, downstream therefrom, an analog-to-digital converter 310. One function of the ADC 310 may be to digitize the voice signal for coupling to the analog front end circuit. Another function of the ADC 310 will be described below. The ADC 310 may be physically located on the sound card 108 (FIG. 1).

Continuing to refer to FIG. 3, the audio signal path 302 may also include a sample rate converter 312 coupled between the ADC 310 and the analog front end circuit 116. The sample rate converter 312 may be provided to, if necessary, adjust the sample rate of the signal output from the ADC 310 to match the required input sample rate for the analog front end circuit 1 16.

A control function for the audio signal path 302 is schematically illustrated by block 314 in FIG. 3. The control function 314 may operate to detect nonlinear distortion in the voice signal and to control the gain applied to the voice signal to prevent or minimize distortion. As a practical matter, the control function 314 may be implemented with suitable software to control the microprocessor 202 (FIG. 2) of the host computer 102. Accordingly, the microprocessor 202 may function as a control circuit coupled to components of the audio signal path 302.

The control function 314 includes an over sampling block 316 which controls the ADC 310 so that the ADC oversamples the voice signal, e.g., at a rate of 48 kHz, to allow for suitable analysis of the voice signal by the control function 314 as described below.

The oversampled voice signal is supplied from the ADC 310 to a voice activity detector 318 that is part of the control function 314. The voice activity detector 318 detects occasions when voice activity is present in the voice signal generated by the microphone 106.

A window-averaged spectrogram estimation block 320 is responsive to the voice activity detector 318. The window averaged spectrogram estimation block 320 may operate to detect nonlinear distortion in the voice signal. A gain control block 322 is responsive to the window-averaged spectrogram estimation block. The gain control block 322 may selectively control the adjustable gain circuit 306 to control the amount of gain applied to the voice signal by the adjustable gain circuit.

A signal path 324 may be provided between the analog front end circuit 116 and the control function 314 to allow the control function 314 to received ringback signals. Also, a control signal path 326 may be provided between the control function 314 and the microphone boost circuit 304 to allow the control function 314 to selectively enable and disable the microphone boost circuit 304.

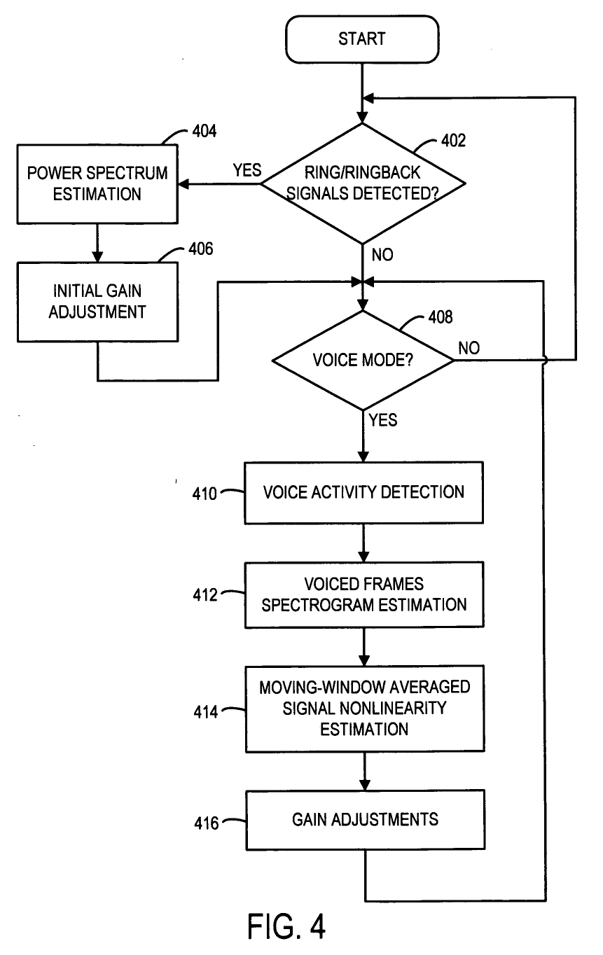

FIG. 4 is a flow chart that illustrates a process performed in accordance with some embodiments by the control function 314, and hence by the microprocessor 202 (FIG. 2). The process of FIG. 4 may be performed by the microprocessor 202 under control of suitable software instructions stored in the memory device(s) 204.

In the process of FIG. 4, a ring signal and/or a ringback signal may be detected at decision block 402. If so, then the control function may perform a power spectrum estimation, as indicated at 404, and if appropriate may cause an initial adjustment (as indicated at 406) to the gain applied to the voice signal by the adjustable gain circuit 306. At decision block 408, the control function 314 determines whether the modem 110 (FIG. 1) is operating in a voice mode (e.g., a speakerphone mode) rather than a data communication mode. If so, the control function next detects (as indicated at 410) whether there is voice activity in the signal in the audio signal path 302. For signal frames in which voice activity is present, the control function estimates a spectrogram of the voice signal in those frames, as indicated at 412. The control function next estimates whether there is significant nonlinearity in the voice signal, as indicated at 414. This estimate may be based on a moving average, taken over a number of window periods, of the portion of the voice signal energy that is outside of a frequency band such as a voice signal frequency band. In some embodiments the voice signal frequency band may be frequencies up to about 4 kHz. Thus the nonlinearity estimate may be based on the detected signal energy level above 4 kHz. (Other voice band frequency limits may be used.)

As indicated at 416, the control function may cause adjustments (e.g., reductions) in the gain applied to the voice signal by the adjustable gain circuit 306, based at least in part on the estimated energy level of the voice signal outside of the voice frequency band. For example, the energy level above the voice frequency band may be compared with a threshold, and the gain applied by the adjustable gain circuit 306 may be reduced if the energy level above the voice frequency band exceeds the threshold.

In some embodiments, the microphone boost circuit 304 may be disabled at the same time the gain applied by the adjustable gain circuit 306 is adjusted.

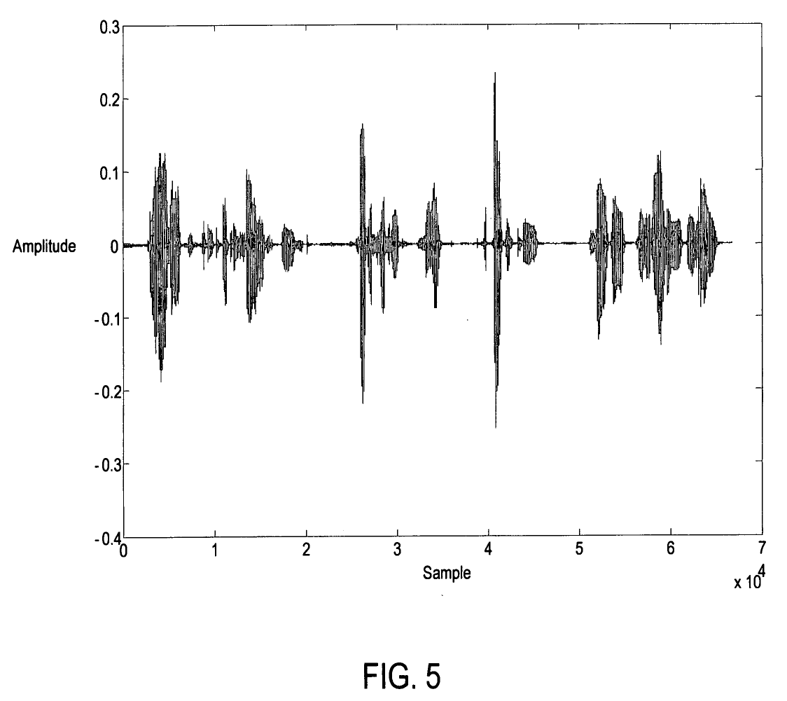

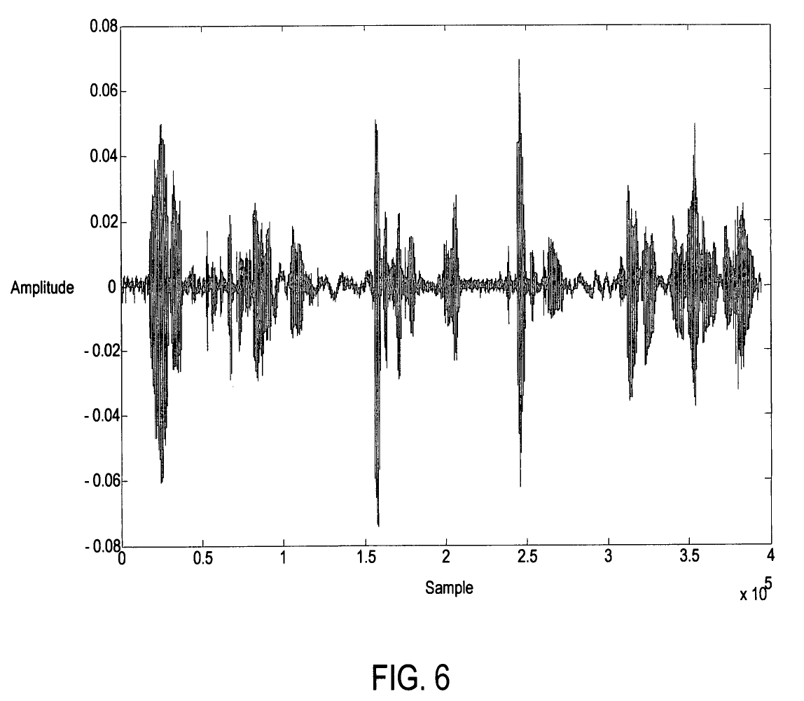

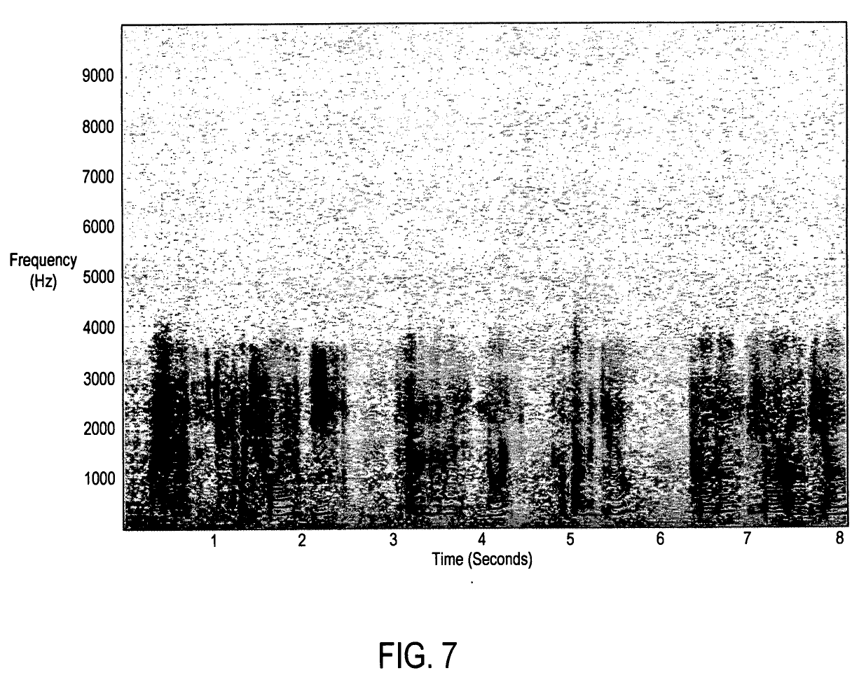

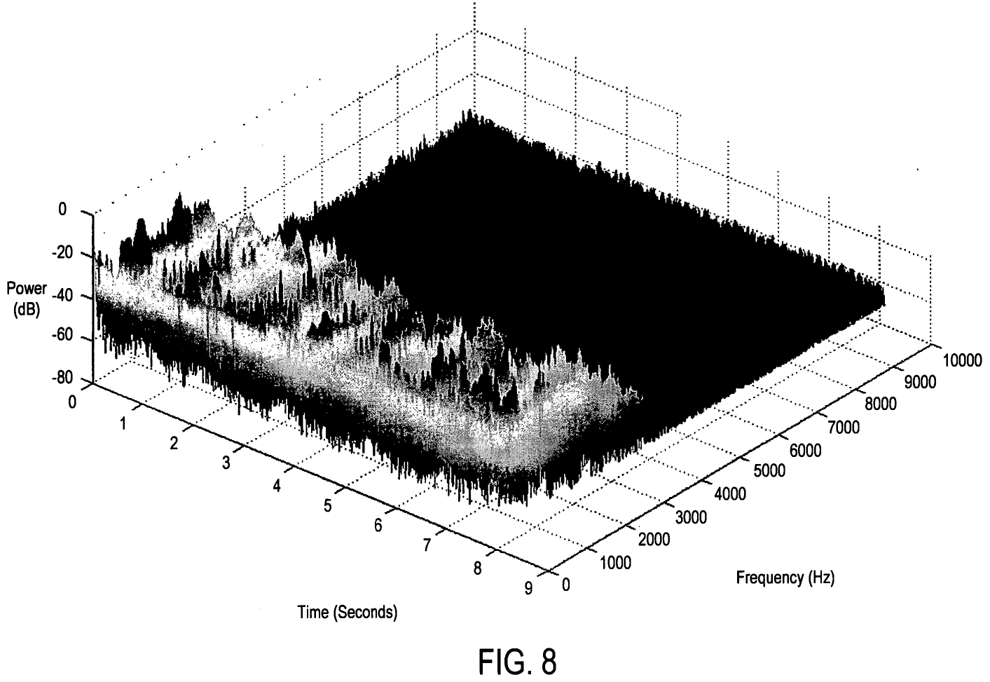

FIG. 5 is a simulated plot of a test voice signal that may be applied to the system 100. FIG. 6 is a simulated plot of the test signal of FIG. 5, when oversampled at 48 kHz and with microphone boost circuit 304 disabled and microphone volume control set at midrange. FIG. 7 is a simulated 2D spectrogram of the test signal under these conditions, and FIG. 8 is a simulated 3D spectrogram of the test signal under these circumstances. It will be noted that virtually none of the signal energy is above 4 kHz in this situation.

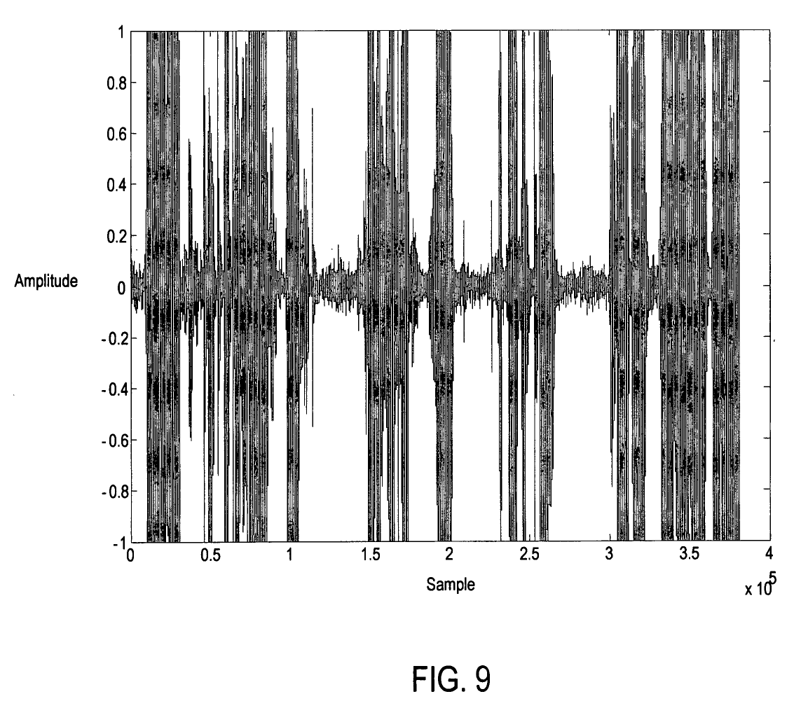

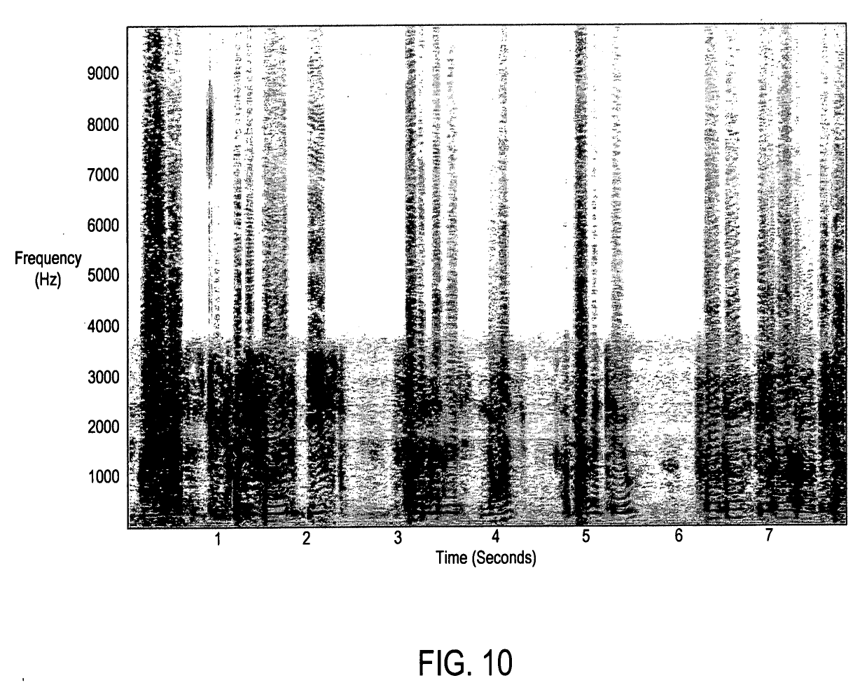

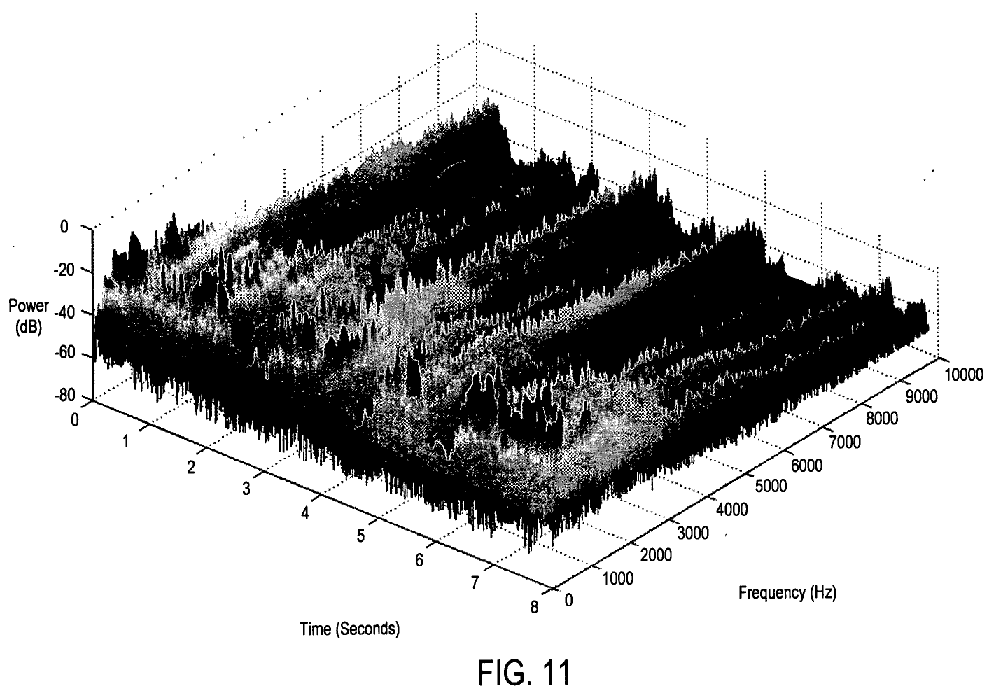

FIG. 9 is a simulated plot of the test signal, when oversampled and with microphone boost applied and the microphone volume control set at a high level, and without gain adjustment. FIGS. 10 and 11 are respectively simulated 2D and 3D spectrograms of the simulated signal shown in FIG. 9. In this situation clipping occurs and the voice energy spreads above 4 kHz.

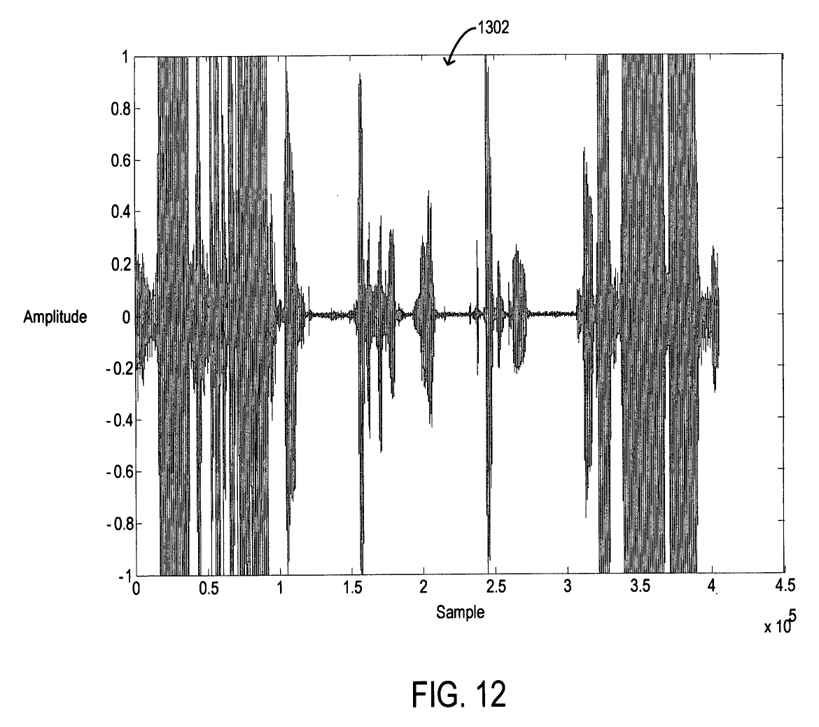

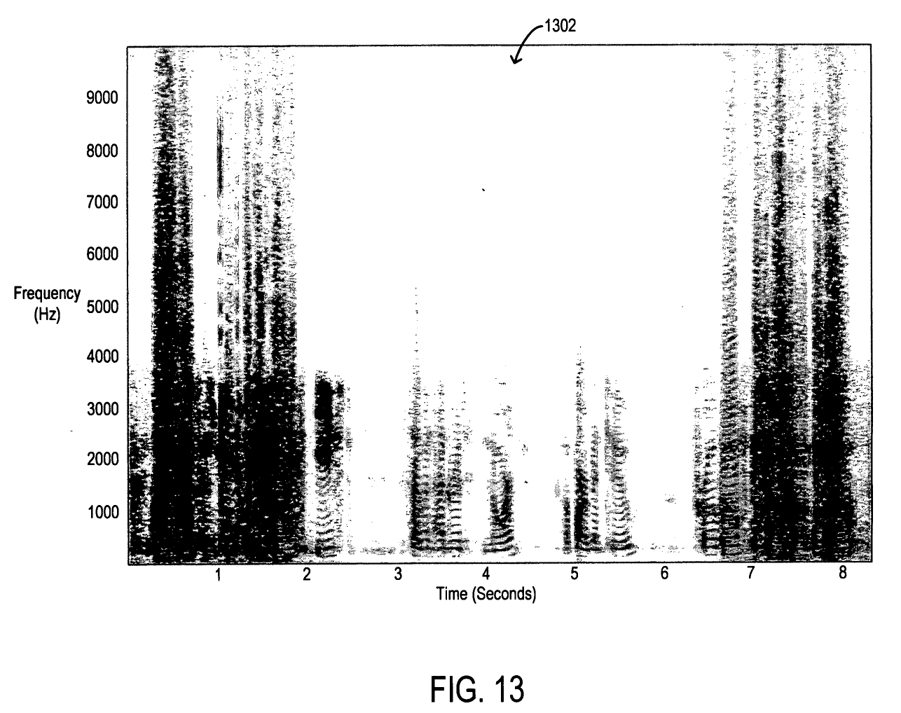

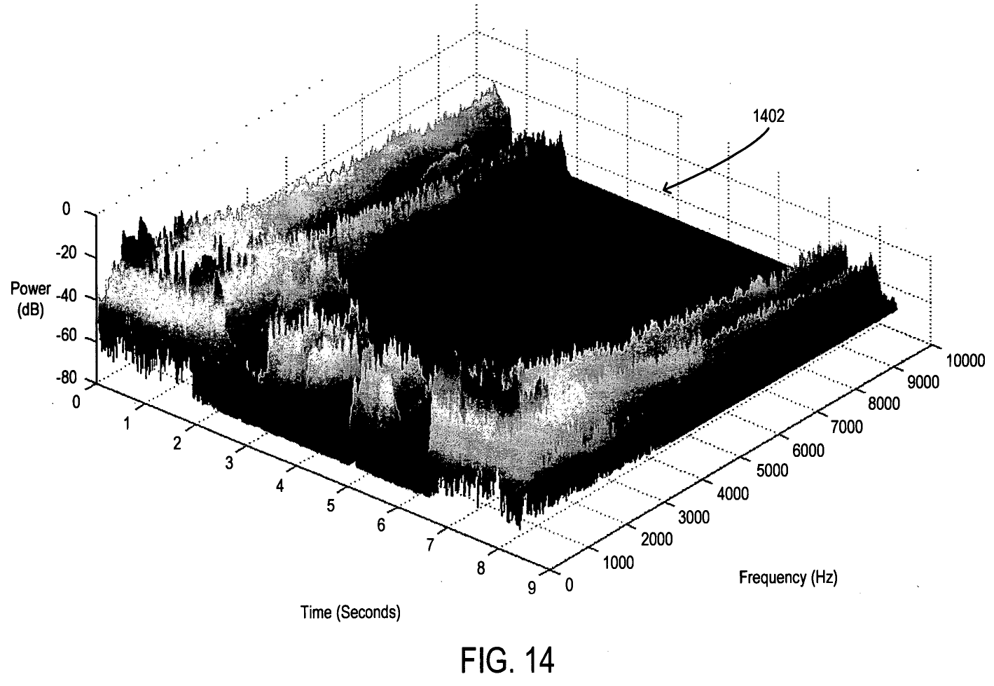

FIG. 12 is a simulated plot of the test signal when oversampled, with microphone boost applied and the microphone volume control set at a high level, but with gain adjustment in accordance with FIG. 4 applied at least intermittently. FIGS. 13 and 14 are the corresponding simulated 2D and 3D spectrograms, respectively. After speech activity is detected, the nonlinearity (out of band energy above the threshold) is detected and gain adjustment is applied to substantially eliminate the nonlinear distortion, as can be seen from the regions 1202 (FIG. 12), 1302 (FIG. 13) and 1402 (FIG. 14). In some embodiments, the gain adjustments may be maintained in effect for a certain period of time (e.g., 4.5 seconds) and at the end of that time the gain of the adjustable gain circuit 306 may then be returned to its default level. The out of band energy level may again be estimated at that point to determine whether the gain adjustment should be resumed.

With this arrangement, nonlinear distortion may be automatically mitigated, and sound quality at the receiving end improved, without requiring intervention by the parties to the telephone call, and without requiring transmission of special test signals or the like. Further, this approach to controlling nonlinear distortion may facilitate proper operation of the automatic echo cancellation function, which might otherwise be interfered with by the presence of nonlinear distortion.

FIGS. 5-14 are provided for illustration purposes only and are not meant to limit the invention.

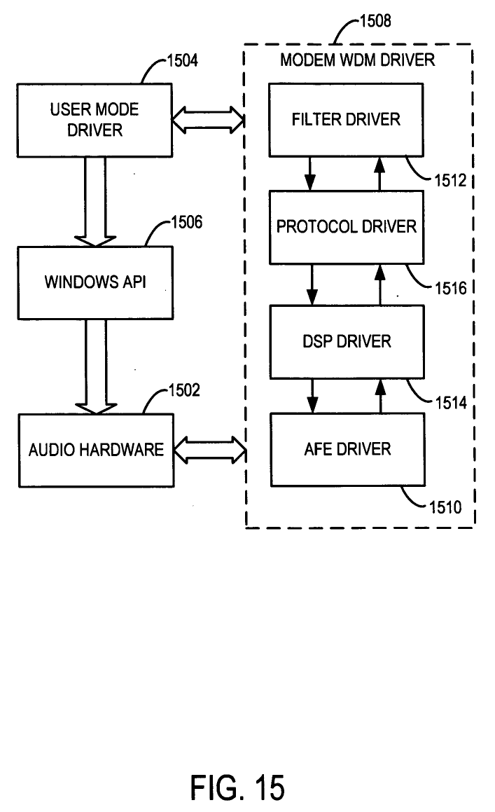

FIG. 15 is a block diagram illustration of a driver software architecture in which some embodiments may be implemented.

In FIG. 15, block 1502 represents the audio hardware, including for example the sound card 108 (FIG. 1). A user mode driver 1504, which may incorporate some or all of the functionality described with reference to FIG. 4, communicates with the audio hardware 1502 via a Windows application program interface (API) 1506.

Both the user mode driver 1504 and the audio hardware 1502 may be arranged to be in communication with a modem driver 1508 provided in accordance with the Windows Driver Model (WDM). In functioning of the modem driver 1508, samples may be passed from an AFE (analog front end) driver 1510 to a filter driver 1512, via a DSP driver 1514 and a protocol driver 1516. In some embodiments, aspects of the control function 314 (FIG. 3) may be incorporated in either or both of the filter driver 1512 and the DSP driver 1514. In other embodiments, the functionality of the control function 314 may be partitioned in other ways among the software components illustrated in FIG. 15.

The several embodiments described herein are solely for the purpose of illustration. The various features described herein need not all be used together, and any one or more of those features may be incorporated in a single embodiment. Therefore, persons skilled in the art will recognize from this description that other embodiments may be practiced with various modifications and alterations.

What is claimed is:

1. An apparatus comprising:
a microphone to generate a voice signal;
an adjustable gain circuit coupled to the microphone to selectively apply a gain to the voice signal;
an analog front end circuit coupled to the adjustable gain circuit to transmit the voice signal; and
a control circuit coupled to the adjustable gain circuit and operative to:
detect an average level of energy of the voice signal outside of a voice frequency band; and
control, based at least in part on the detected average level of energy, an amount of gain applied to the voice signal by the adjustable gain circuit.

2. The apparatus of claim 1, wherein the control circuit is a microprocessor that is part of a computer to which the microphone is coupled.

3. The apparatus of claim 2, wherein software instructions to control the microprocessor to detect the average level of energy of the voice signal are part of a modem driver software component stored in the computer.

4. The apparatus of claim 1, wherein the control circuit is operative to:
compare with a threshold the detected average level of energy of the voice signal outside of the voice frequency band; and
control the adjustable gain circuit to reduce the amount of gain applied to the voice signal by the adjustable gain circuit when the detected average level of energy exceeds the threshold.

5. The apparatus of claim 1, further comprising:
a speaker coupled to the analog front end circuit to audibly reproduce a signal received via the analog front end circuit.

6. The apparatus of claim 5, further comprising:
an automatic echo cancellation circuit coupled to the microphone to automatically cancel a signal picked up by the microphone from the speaker.

7. The apparatus of claim 1, further comprising:
a microphone boost circuit coupled between the microphone and the adjustable gain circuit, the microphone boost circuit operative to apply a fixed gain to the voice signal at times when the microphone boost circuit is enabled, the microphone boost circuit coupled to the control circuit, the control circuit operative to selectively enable and disable the microphone boost circuit.

8. The apparatus of claim 1, further comprising:
a sound card coupled to the microphone; and
a modem coupled to the sound card, the modem including the analog front end circuit.

9. The apparatus of claim 8, wherein the modem is coupled to and controlled by the control circuit.

10. The apparatus of claim 1, further comprising:
a sampling circuit coupled downstream from the adjustable gain circuit to provide to the control circuit a sequence of digital samples of the voice signal.

11. A method comprising:
detecting an average level of energy of a signal, the detected average level indicative of an energy level of the signal outside a voice frequency band; and
controlling, based at least in part on the detected average level, an amount of gain applied to the signal.

12. The method of claim 11, wherein the signal is a voice signal generated by a microphone interfaced to a computer.

13. The method of claim 12, further comprising:
selectively disabling a microphone boost circuit coupled to the microphone.

14. The method of claim 11, further comprising:
comparing with a threshold the detected average level; and
reducing an amount of gain applied to the signal when the detected average level exceeds the threshold.

15. An apparatus comprising:
a storage medium having stored thereon instructions that when executed by a machine result in the following:
detecting an average level of energy of a signal, the detected average level indicative of an energy level of the signal outside a voice frequency band; and
controlling, based at least in part on the detected average level, an amount of gain applied to the signal.

16. The apparatus of claim 15, wherein the instructions, when executed by the machine, further result in:
selectively disabling a microphone boost circuit coupled to a microphone.

17. The apparatus of claim 15, wherein the instructions, when executed by the machine, further result in:
comparing with a threshold the detected average level; and
reducing an amount of gain applied to the signal when the detected average level exceeds the threshold.

18. The apparatus of claim 15, wherein the instructions to detect the average level of energy of the voice signal are part of a modem driver component for the machine.

19. The apparatus of claim 15, wherein the instructions, when executed by the machine, further result in:
detecting a ringback signal.

20. The apparatus of claim 15, wherein the instructions, when executed by the machine, further result in:
detecting a ring signal.
